(19) United States
(12) Patent Application Publication
(10) Pub. No.: US 2008/0034043 A1
(43) Pub. Date: Feb. 7, 2008

(54) ELECTRONIC MAIL MESSAGE REPLAY CONSTRAINTS

(75) Inventors: Rajeev H. Gandhi, Cedar Park, TX (US); Scott Lee Winters, Austin, TX (US); Richard Alan Zevin, Austin, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/462,063

(22) Filed: Aug. 3, 2006

(51) Int. Cl. G06F 15/16

(52) U.S. Cl. 709/206

(57) ABSTRACT

A method, article, and system for providing a sender of an electronic mail message (hereafter referred to as email) a means to specify to a recipient a reply length constraint for the text body of the reply message, as well as criteria for the size, number, and type of allowed attachments associated with the reply message. The sender specified reply length constraints for the text message body can be stated in terms of number of lines, number of sentences, and/or by word count. The sender reply attachment constraints can be specified in terms of number of attachment files, maximum size per attachment, and/or receiver supported file types. The method includes having the sender determine the desired reply message constraints or parameters prior to sending out a message, and appending the constraint parameters to the outgoing email. At a receiving terminal that supports the novel features of the present invention, the email will have additional marked text that may be highlighted, italicized, colorized, placed in boxes, etc. to alert the reader that the sender prefers the reply to be constrained within the specified limits. If the reply from the receiving terminal does not meet the specified constraints, the reply will not be sent and appropriate warning will be displayed to the reader. For a receiving terminal that does not support the novel features of the present invention, a simple text message will appear with the sender reply constraint parameters.

### BACKGROUND OF THE INVENTION

1. Field of the Invention

This invention relates generally to electronic mail messaging, and more particularly to providing a method, article, and system for constraining the size and length of electronic mail responses and the size, number, and types of associated content attachments sent by a recipient to an originating electronic mail message.

2. Description of the Related Art

Electronic mail has become a central feature of modern life and users have come to expect to receive electronic mail messages at any time and in virtually any place. For example, during the course of one day of travel, a user may receive electronic mail messages at a home desktop computer in the early morning, an office desktop computer in midmorning, via a cell phone or personal digital assistant in a taxi on the way to the airport, on a laptop computer via a wireless local area network while waiting in the airport lounge, via an in-flight telephone on the airplane, and in a hotel room via a high-speed Internet connection provided by the hotel at the end of the day.

Thus, depending on the circumstances, electronic mail messages may be transmitted and/or received by a wide variety of devices at any given time. In addition to the aforementioned end-user devices, such as desktop computers, laptop computers, cell phones, personal digital assistants, and the like, electronic mail messages typically also pass through a variety of network servers, network switches, hubs, routers, transmission lines, wireless transmission media, modems, interface cards, and the like. The transfer rates of these devices and/or media can vary by many orders of magnitude. For example, a laptop computer modem may be limited to a transfer rate of 56K bits per second, a cable modem may easily provide data at a transfer rate of 1-2 megabits per second, and a T-3 connection may provide data at a transfer rate as high as 40 megabits per second.

The complexity and size of electronic mail messages has increased roughly in proportion with the available transfer rates. Early electronic mail message systems relied upon comparatively slow modems and thus these electronic mail messages were typically limited to short ASCII text documents. Modern electronic mail messaging systems, on the other hand, may utilize high-speed connections to transmit documents containing complex formatting, audio, graphics, video, and the like. For example, a user may send and/or receive an electronic mail message with a multimedia attachment including formatted text, images, and animations. In another example, a user with the appropriate licenses may send and/or receive a feature length movie as an electronic mail message. The size of these files may easily exceed several megabytes, and users can be expected to transmit even larger files in the future.

Despite the advantages of using high-speed connections to transmit large information-rich electronic mail messages, the same messages can become problematic when they must be transmitted by a lower speed connection. For example, a user reading electronic mail messages on a laptop computer connected to the Internet via a 14.4K dial-up modem may have to wait an inordinate amount of time for a large electronic mail message to be downloaded through the modem. As another example, a user writing electronic messages on the laptop computer connected to the Internet via a 14.4 KB dial-up modem may want to attach a large document to an electronic mail message, but may have to wait an unreasonable amount of time for the electronic mail message to be uploaded through the modem. In addition, bottlenecks, heavy traffic, device malfunctions, severed transmission lines, geomagnetic storms, and the like can dramatically, and often unpredictably, decrease the transfer rate of even the highest speed networks. Consequently, the user may have to wait an unreasonable amount of time to receive any indication of the content of the electronic mail message, including any attached files.

Moreover, it may be difficult for the user to determine what information may be contained in the electronic mail message without receiving the entire message. For example, conventional electronic mail messaging systems are not typically able to identify and/or provide relevant portions of electronic mail message attachments to the user unless the user has received the entire message. The large number of different file formats or file types that may be included in the attachments exacerbates this problem. In addition, executable attachments may represent a security risk to a receiving computer or network.

As the length of emails increase so does the proportionate amount of time required by the reader to digest the information. Time is a precious commodity that most users lack and look to conserve. Unnecessarily long emails are something that should be avoided, and the subsequent time saving would be of benefit to both the sender and the receiver.

The present invention is directed to addressing, or at least reducing, the effects of, one or more of the problems set forth above, by giving the sender of electronic messages a means for controlling the length of replied emails and the size, number, and types of associated content attachments.

### SUMMARY OF THE INVENTION

In one aspect of the present invention, a method of providing a means for a sender of an electronic mail message (hereafter referred to as email) to specify to a recipient a reply length constraint for the text body of the reply message, as well as criteria for the size, number, and type of allowed attachments associated with the reply message. The sender specified reply length constraints for the text message body can be stated in terms of number of lines, number of sentences, and/or by word count. The sender reply attachment constraints can be specified in terms of number of attachment files, maximum size per attachment, and/or receiver supported file types. The method includes having the sender determine the desired reply message constraints or parameters prior to sending out a message, and appending the constraint parameters to the outgoing email. At a receiving terminal that supports the novel features of the present invention, the email will have additional marked text that may be highlighted, italicized, colorized, placed in boxes, etc. to alert the reader that the sender prefers the reply to be constrained within the specified limits. If the reply from the receiving terminal does not meet the specified constraints, the reply will not be sent and appropriate warning will be displayed to the reader. For a receiving terminal that does not support the novel features of the present invention, a simple text message will appear with the sender reply constraint parameters. A system for implementing the method of reply constraint, as well as an article comprising one or more machine-readable storage media containing instructions that when executed enable a processor to carry out the method, are also provided.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a system for practicing one or more embodiments of the present invention.

FIG. 2 shows one exemplary embodiment of a sender pull down menu user interface for specifying email reply length constraint parameters.

FIG. 3A is a flow diagram illustrating one embodiment of a method for a sending party to provide email reply length and attachment constraint parameters.

FIG. 3B is a flow diagram illustrating one embodiment of a method of handling reply mail when subject to the reply email constraints.

The detailed description explains the preferred embodiments of the invention, together with advantages and features, by way of example with reference to the drawings.

### DETAILED DESCRIPTION OF SPECIFIC EMBODIMENTS

Turning now to the drawings as described in detail below, the present invention provides for a sender of an email to specify to a receiver(s) a reply length constraint for the text body of the reply message, as well as a criteria for the size, number, and types of allowed attachment files associated with the reply message.

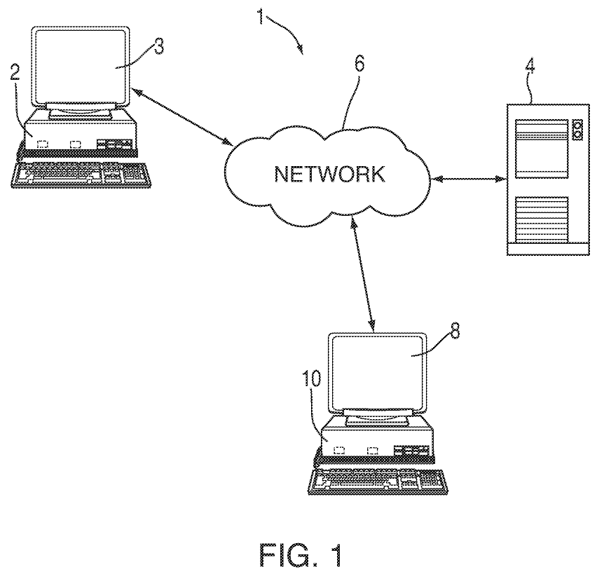

FIG. 1 is a block diagram of an exemplary system 1 for implementing the email reply controls of the present invention and graphically illustrates how those blocks interact in operation. The system includes one or more email sending workstations 2 coupled to a server system 4 via a network 6. Each email sending workstation 2 may be implemented using a general-purpose computer executing a computer program for carrying out the processes described herein. The computer program may be resident on a storage medium local to the sending workstation 2, or maybe stored on the server system 4. The server system 4 may belong to a public email service. The network 6 may be any type of known network including a local area network (LAN), wide area network (WAN), global network (e.g., Internet), intranet, etc. The email sending workstations 2 may be coupled to the server system 4 through multiple networks (e.g., intranet and Internet) so that not all email sending workstations 2 are coupled to the server system 4 via the same network. The sending workstations 2 and the server system 4 may be connected to the network 6 in a wireless fashion, and network 6 may be a wireless network. In a preferred embodiment, the network 6 is a LAN and each sending workstation 2 executes a user interface application (e.g., web browser) to contact the server system 4 through the network 6. Alternatively, a sending workstation 2 may be implemented using a device programmed primarily for accessing network 6 such as a remote client.

In addition to sending workstations 2, the system includes one or more email receiving workstations 10 coupled to server system 4. Each receiving workstation 10 may be implemented using a general-purpose computer executing a computer program for carrying out the processes described herein. The computer program may be resident on a storage medium local to the receiving workstation 10, or maybe stored on the server system 4. The sending workstations 2 and the receiving workstations 10 may access the server system 4 over the same or different networks (e.g., an intranet and Internet). In a preferred embodiment, the receiver workstations 10 execute a user interface application (e.g., web browser) to contact the server system 4 through the network 6. Alternatively, the receiver workstations 10 may be implemented using a device programmed primarily for accessing network 6 such as a remote client. It should also be noted that both the email sending workstations 2 and receiving workstations 10 could change roles and act as receiver or sender work station, respectively.

The e-mail program of the present invention provides functionality to the user with the same options for sending e-mail messages as in prior art programs, but with the additional ability to allow the user to specify to a recipient(s) a reply length constraint for the text body of the reply message, as well as a criteria for the size, number, and types of allowed file attachments associated with the reply message.

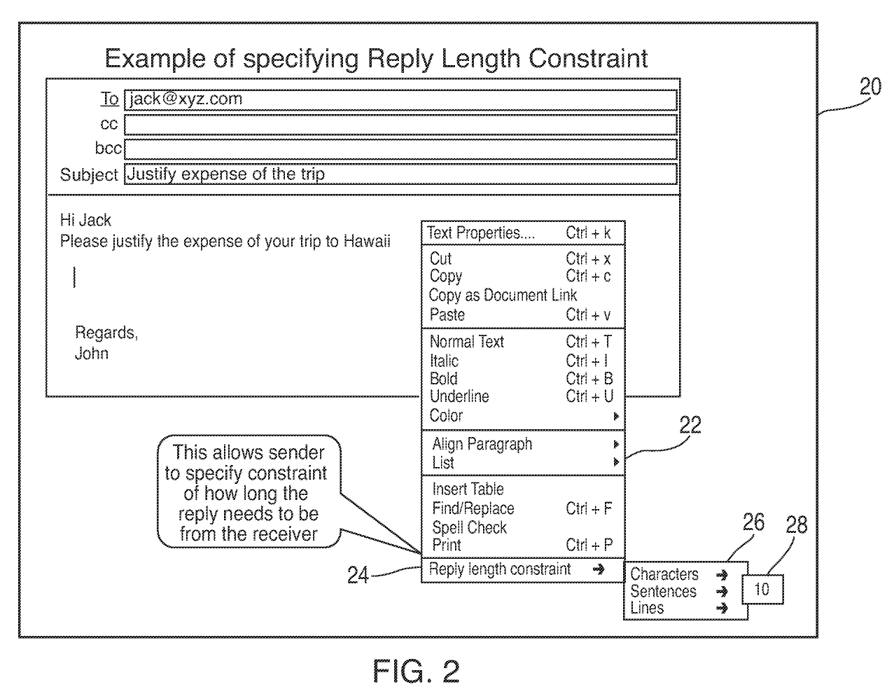

The program of the present invention generates and displays, by well-known software methods, a graphical user interface to the user of a computer on which the program is running. An example of such a user interface is shown in FIG. 2. In the figure, graphical user interface (GUI) 20, as displayed on the screen 3 of sending workstation 2 (please see FIG. 1), presents the user with a suite of functions allowing him or her to set up and send an e-mail message to one or more recipients. A pull down menu 22 is provided by the GUI 20 to allow the user to select certain options and/or shortcuts to options by clicking on representative icons with a mouse or other similar selecting or pointing device. Among the functions provided in the pull down menu 22 is the ability to control reply messages from recipients. In the example provided, when the user selects Reply length constraint 24, the GUI 20 presents further user selectable options 26 for number of characters, sentences, or lines. In the present example, the user chose to set a limit of ten sentences (28) in a reply message from a recipient. In a similar fashion the GUI 20 can provide options for the user to control the size, number, and types of allowed file attachments associated with the reply message from a recipient. At a receiver workstation 10 that supports the novel features of the present invention, the email will be displayed on screen 8 with additional marked text that may be highlighted, italicized, colorized, placed in boxes, etc. to alert the reader that the sender prefers the reply to be constrained within the specified limits. If a receiving terminal does not support the novel features of the present invention, a simple text message will appear with the sender reply constraint parameters.

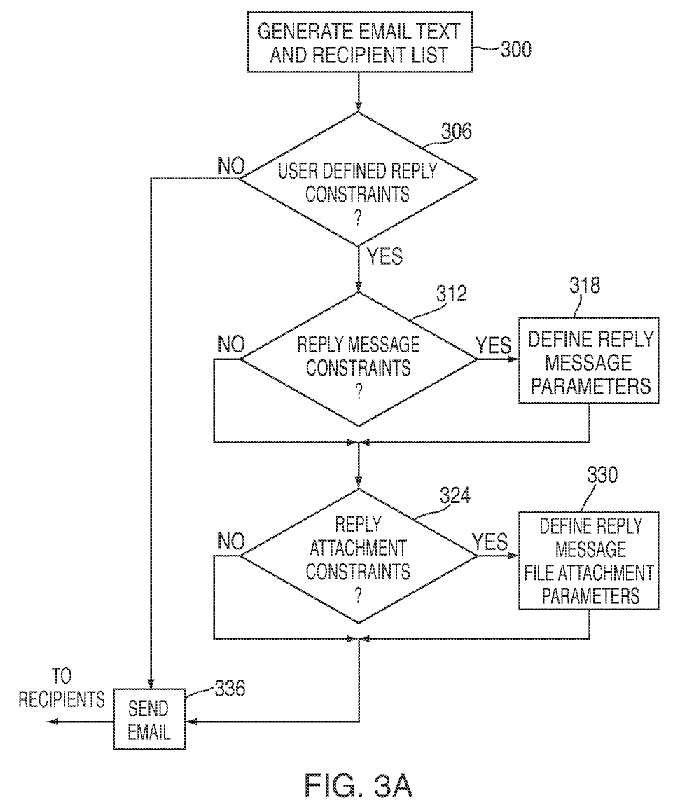

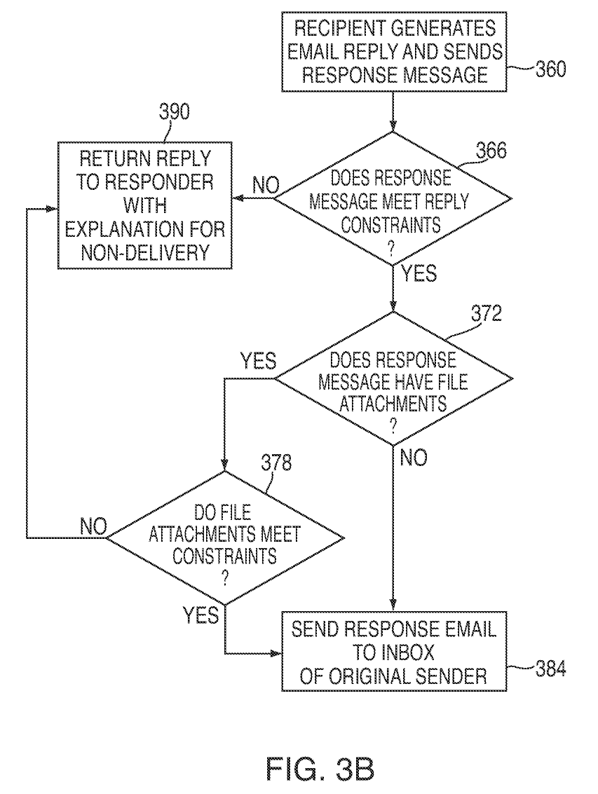

FIG. 3A is a flow diagram illustrating a process for generating e-mail with reply constraints in accordance with a preferred embodiment of the present invention. As shown in the figure, in step 300, a sender composes an email message in a customary manner. At step 306, the sender can optionally choose to use the features of the present invention to constrain the reply messages, or proceed to send the email at step 336. If the sender does in fact decide to add reply constraints the process flows to step 312, where the sender decides on adding constraints based on the message itself and proceeds to step 318 to define constraint parameters and/or the sender may also optionally choose (324) to add reply file attachment constraints (330). Subsequently, the sender emails the message (336) to the recipient(s).

The recipient generates a message (360) in FIG. 3B in response to the email of FIG. 3A. If the message conforms to the reply constraints (366) it is allowed to proceed to the email inbox of the original sender. If the reply email does not conform to the reply constraints (366), an email is sent to the recipient with an explanation for the non-delivery (390) of the reply email. In addition, at step 372 the email is checked for file attachments. In a similar fashion, if the file attachment(s) conform to the constraints (378), the attachment(s) are allowed to proceed to the senders email inbox (384), or an email is sent to the recipient with an explanation for the non-delivery (390) of the file attachments.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for a sender to constrain the size and length of electronic mail responses, as well as, the size, number, and types of associated content attachments sent by recipients in response to an originating electronic mail message, by employing an electronic mail program, said method comprising:
said sender selecting constraint parameters for the size and length of said electronic mail responses;
said sender selecting constraint parameters for the size, number, and
types of said associated content attachments;
sending said originating electronic mail message to said recipients with said response constraint parameters.

2. The method of claim 1 wherein said constraint parameters for the size and length of said electronic mail responses further comprises:
said sender selecting a limit on the number of characters in said recipient electronic mail response.

3. The method of claim 1 wherein said constraint parameters for the size and length of said electronic mail responses further comprises:
said sender selecting a limit on the number of sentences in said recipient electronic mail response.

4. The method of claim 1 wherein said constraint parameters for the size and length of said electronic mail responses further comprises:
said sender selecting a limit on the number of lines in said recipient electronic mail response.

5. The method of claim 1 wherein said constraint parameters for the size, number, and types of said associated content attachments sent by said recipients in response to said originating electronic mail message further comprises:
said sender selecting file types of said attachments in said recipient electronic mail response based on the supported file types of said sender.

6. The method of claim 1 wherein said constraint parameters for the size, number, and types of said associated content attachments sent by said recipients to said originating electronic mail message further comprises:
said sender selecting file types of said attachments in said recipients electronic mail response based on security concerns.

7. The method of claim 1 wherein said selection of constraint parameters for said recipient reply message and said associated attachments is performed by said sender through the use of a graphical user interface that is integrated into said electronic mail program.

8. The method of claim 1 wherein said recipients are notified of said sender's reply constraints within the body of said originating electronic mail message.

9. The method of claim 1 wherein said sender's electronic mail program rejects said recipient response for not complying with said response constraint parameters.

10. The method of claim 1 wherein said recipients are notified if their response to said originating electronic mail message has been rejected by said sender's electronic mail program for not conforming to said reply constraints.

11. An article comprising one or more machine-readable storage media containing instructions that when executed enable a processor to:
access an electronic mail message for delivery to recipients at remote devices;
facilitate a sending user in selecting parameters to constrain the size and length of electronic mail responses, as well as, the size, number, and types of associated content attachments sent by recipients in response to an originating electronic mail message.

12. The article of claim 11, wherein the instructions that when executed enable the processor to set a limit on the allowed number of characters in said recipient electronic mail response; and
wherein said article has the ability to determine a character count of said recipient electronic mail response; and
wherein based on said character count said article can reject and return to said recipient said electronic mail response; and
wherein said article automatically notifies said recipient on the reason for the rejection of said electronic mail response.

13. The article of claim 11, wherein the instructions that when executed enable the processor to set a limit on the allowed number of lines in said recipient electronic mail response; and
wherein said article has the ability to determine a line count of said recipient electronic mail response; and
wherein based on said line count said article can reject and return to said recipient said electronic mail response; and
wherein said article automatically notifies said recipient on the reason for the rejection of said electronic mail response.

14. The article of claim 11, wherein the instructions that when executed enable the processor to set a limit on the allowed number of sentences in said recipient electronic mail response; and
wherein said article has the ability to determine a sentence count of said recipient electronic mail response; and
wherein based on said sentence count said article can reject and return to said recipient said electronic mail response; and
wherein said article automatically notifies said recipient on the reason for the rejection of said electronic mail response.

15. The article of claim 11, wherein the instructions that when executed enable the processor to determine the size, number, and types of said associated content attachments sent with a recipient electronic mail response;
wherein based on said size determination said article can reject and return said associated content attachments sent with said recipient's electronic mail response; and
wherein based on said number determination said article can reject and return said associated content attachments sent with said recipient's electronic mail response; and
wherein based on said type determination said article can reject and return said associated content attachments sent with said recipient's electronic mail response; and wherein said article automatically notifies said recipient on the reason for the rejection of said electronic mail response.

16. A system for a sender to constrain the size and length of electronic mail responses, as well as, the size, number, and types of associated content attachments sent by recipients in response to an originating electronic mail message by employing an electronic mail program, said system comprising:
at least one email sending device;
a server system;
at least one network; and
at least one receiving device;
wherein said email sending device is implemented using a general-purpose computer executing said electronic mail program; and
wherein said electronic mail program is resident on a storage medium local to said email sending device; and
wherein said email sending device is coupled to said server system via said network; and
wherein said receiving devices are coupled to said server system via said network.

17. The system of claim 16 wherein said electronic mail program is resident on said server system.

18. The system of claim 16 wherein said network may be any type of known network including, but not limited to, a local area network (LAN), wide area network (WAN), Internet, intranet, and wireless networks.

19. The system of claim 16 wherein said email sending devices and said receiving devices are mobile devices with wireless communication capabilities.

20. The system of claim 16 wherein said electronic mail program provides a graphical user interface to said sender for setting said reply constraints.
